(19) United States
(12) Patent Application Publication
(10) Pub. No.: US 2015/0077687 A1
(43) Pub. Date: Mar. 19, 2015

(54) LIQUID CRYSTAL DISPLAY DEVICE

(71) Applicant: WINTEK CORPORATION, Taichung City (TW)

(72) Inventors: Hsien-Wei CHIANG, Taipei City (TW); Guan-Ren WANG, Tainan City (TW); Kuan-Hsien WU, Pi Tou Hsiang (TW)

(21) Appl. No.: 14/484,698

(22) Filed: Sep. 12, 2014

(30) Foreign Application Priority Data
Sep. 13, 2013 (TW) 102133254

(51) Int. Cl. G02F 1/1343; G02F 1/1335; G02F 1/1333; G02F 1/1339

(52) U.S. Cl. CPC G02F 1/134309; G02F 1/13394; G02F 1/13439; G02F 1/133512; G02F 1/133345; G02F 2001/134345
USPC 349/110; 349/156; 349/138; 349/139; 349/122

(57) ABSTRACT

A liquid crystal display device includes a first substrate, a second substrate opposite the first substrate, a fence structure, a plurality of cholesteric liquid crystals having mutually different color, and a medium layer. The fence structure is disposed between the first substrate and the second substrate to divide a space between the first substrate and the second substrate into different sub-pixel channels. The cholesteric liquid crystals are disposed into the sub-pixel channels to form different liquid crystal cells having mutually different colors. The medium layer is disposed in at least one of the sub-pixel channels to allow the liquid crystal cells to have mutually different cell gaps.

### BACKGROUND OF THE INVENTION

a. Field of the Invention

The invention relates to a liquid crystal display device.

b. Description of the Related Art

In a conventional cholesteric liquid crystal display device, a red, a green and a blue cholesteric liquid crystal are separately driven to display a color image. As shown in FIG. 1, typically, the red cholesteric liquid crystal is driven at a voltage of about 30-40V, the green cholesteric liquid crystal is driven at a voltage of about 36-46V, and the blue cholesteric liquid crystal is driven at a voltage of about 38-50V. Therefore, the cholesteric liquid crystals of different colors are applied with respective voltage intervals. In that case, for example, a driving voltage interval for the red cholesteric liquid crystal is not suitable for the blue cholesteric liquid crystal. Therefore, three distinct driving voltages should be provided for the cholesteric liquid crystals of different colors to write grayscale pixel data and thus complicate the entire driving architecture.

### BRIEF SUMMARY OF THE INVENTION

The invention provides a liquid crystal display device having simplified driving architecture.

According to an embodiment of the invention, a liquid crystal display device includes a first substrate, a second substrate opposite the first substrate, a fence structure, a plurality of cholesteric liquid crystals having mutually different color, and a medium layer. The fence structure is disposed between the first substrate and the second substrate to divide a space between the first substrate and the second substrate into different sub-pixel channels. The cholesteric liquid crystals are disposed into the sub-pixel channels to form different liquid crystal cells having mutually different colors. The medium layer is disposed in at least one of the sub-pixel channels to allow the liquid crystal cells to have mutually different cell gaps.

According to another embodiment of the invention, a liquid crystal display device includes a first substrate, a second substrate opposite the first substrate, a fence structure, a plurality of cholesteric liquid crystals having mutually different color, and a plurality of medium layers. The fence structure is disposed between the first substrate and the second substrate to divide a space between the first substrate and the second substrate into different sub-pixel channels. The cholesteric liquid crystals are disposed into the sub-pixel channels to form different liquid crystal cells having mutually different colors. The medium layers are respectively disposed in the sub-pixel channels and have mutually different dielectric constants.

According to another embodiment of the invention, a liquid crystal display device includes a first substrate, a second substrate opposite the first substrate, a fence structure, a plurality of cholesteric liquid crystals having mutually different color, and a plurality of medium layers. The fence structure is disposed between the first substrate and the second substrate to divide a space between the first substrate and the second substrate into at least a red sub-pixel channel, a green sub-pixel channel, and a blue sub-pixel channel. The cholesteric liquid crystals are respectively disposed inside the red sub-pixel channel, the green sub-pixel channel, and the blue sub-pixel channel to form a red liquid crystal cell, a green liquid crystal cell and a blue liquid crystal cell. The medium layers have mutually different dielectric constants and are disposed in the red sub-pixel channel and the green sub-pixel channel but not in the blue sub-pixel channel.

According to the above embodiments, the electric fields of different color cholesteric liquid crystals respectively in different sub-pixel channels may vary according to the different thicknesses, different material characteristics, or the existence of a medium layer in the different sub-pixel channels. Therefore, the cholesteric liquid crystals of different colors may be all driven by an identical voltage to thus simplify the entire driving architecture.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating different driving voltage curves for cholesteric liquid crystals of different colors.

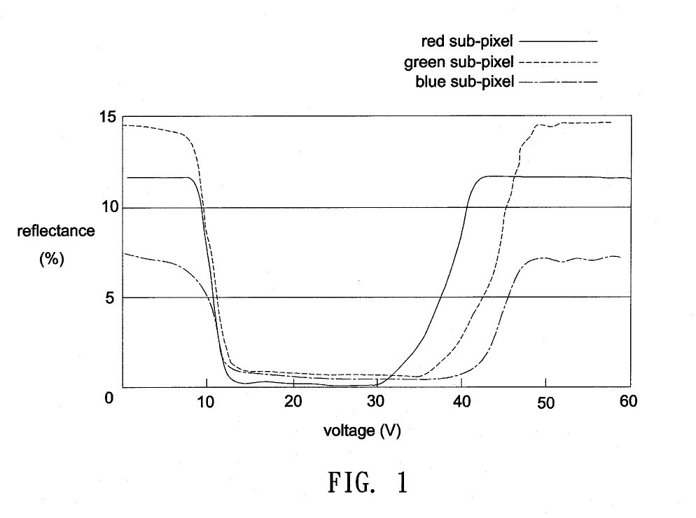

FIG. 2 shows a schematic diagram of a liquid crystal display device according to an embodiment of the invention.

FIG. 3 shows a schematic diagram of a liquid crystal display device according to another embodiment of the invention.

FIG. 4 shows a schematic diagram of a liquid crystal display device according to another embodiment of the invention.

FIG. 5 shows a schematic diagram of a liquid crystal display device according to another embodiment of the invention.

FIG. 6 shows a schematic diagram of a liquid crystal display device according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

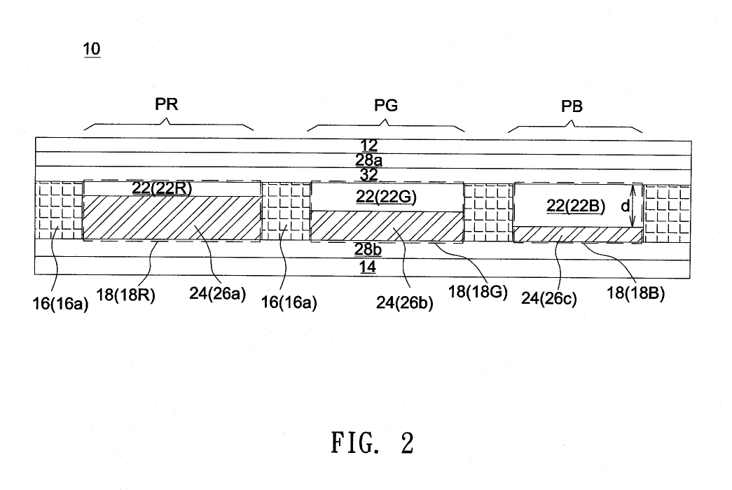

FIG. 2 shows a schematic diagram of a liquid crystal display device according to an embodiment of the invention. Referring to FIG. 2, the liquid crystal display device 10 includes a first substrate 12, a second substrate 14 and a patterned fence structure 16. The fence structure 16 is disposed between the first substrate 12 and the second substrate 14 and divides a space between the first substrate 12 and the second substrate 14 into different sub-pixel channels 18, and multiple cholesteric liquid crystals 22 having mutually different colors are disposed into their respective sub-pixel channels 18 to form liquid crystal cells PR, PG and PB having mutually different colors. For example, in this embodiment, the red cholesteric liquid crystal 22R is disposed into the red sub-pixel channel 18R, the green cholesteric liquid crystal 22G is disposed into the green sub-pixel channel 18G, and the blue cholesteric liquid crystal 22B is disposed into the blue sub-pixel channel 18B. The fence structure 16 may include multiple partition walls 16a to divide the space between the first substrate 12 and the second substrate 14 into different sub-pixel channels 18. Further, a medium layer 24 is disposed in the sub-pixel channels 18R, 18G and 18B, and the medium layer 24 in the sub-pixel channels 18R, 18G and 18B have mutually different thicknesses. In this embodiment, a transparent electrode layer 28a is disposed between the first substrate 12 and the fence structure 16, and another transparent electrode layer 28b is disposed between the second substrate 14 and the fence structure 16. An adhesive layer 32 may be disposed between the transparent electrode layer 28a and the fence structure 16 to avoid an overflow of any of the sub-pixel channels 18. Note the adhesive layer 32 may be omitted from the liquid crystal display device 10, and, in an alternate embodiment, a partition divided by the fence structure 16 may be encapsulated to form a sub-pixel channel 18. The medium layer 24 may be disposed on the transparent electrode layer 28b and may include, for example, a black matrix 26a in the red sub-pixel channel 18R, a black matrix 26b in the green sub-pixel channel 18G, and a black matrix 26c in the blue sub-pixel channel 18B. In this embodiment, a thickness of the black matrix 26a in the red sub-pixel channel 18R is greater than a thickness of the black matrix 26b in the green sub-pixel channel 18G, and a thickness of the black matrix 26b in the green sub-pixel channel 18G is greater than a thickness of the black matrix 26c in the blue sub-pixel channel 18B.

According to the above embodiments, since the black matrixes 26a, 26b and 26c are respectively disposed in the sub-pixel channels 18R, 18G and 18B at mutually different thicknesses, the liquid crystal cells PR, PG and PB may have mutually different cell gaps d. Typically, a voltage sufficient to drive a cholesteric liquid crystal may vary according to a value of the cell gap d. Therefore, according to the above embodiments, the black matrix 26a, 26b and 26c are set to have proper and mutually different thicknesses to equalize the driving voltages needed for cholesteric liquid crystals of different colors. Under the circumstance, the cholesteric liquid crystals of different colors may be all driven by an identical voltage difference to write grayscale pixel data and thus simplify the entire driving architecture.

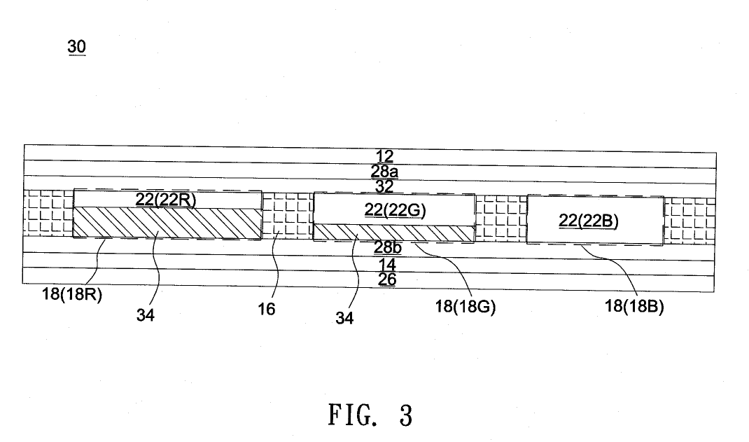

FIG. 3 shows a schematic diagram of a liquid crystal display device according to another embodiment of the invention. Note the medium layer 24 is not limited to a specific material. In an alternate embodiment shown in FIG. 3, the medium layer 24 may be an organic insulation layer 34, and a black matrix layer 26 is disposed on one side of the second substrate 14 facing away from the sub-pixel channels 18. Further, the medium layer 24 is not limited to be disposed in each of the sub-pixel channels 18. For example, in this embodiment, the organic insulation layer 34 of the liquid crystal display device 30 is disposed only in the red sub-pixel channel 18R and the green sub-pixel channel 18G but not disposed in the blue sub-pixel channel 18B. Besides, a thickness of the organic insulation layer 34 in the red sub-pixel channel 18R is greater than a thickness of the organic insulation layer 34 in the green sub-pixel channel 18G. In that case, electric fields of cholesteric liquid crystals may vary according to the thickness or existence of the organic insulation layer 34 in a sub-pixel channel 18. Therefore, the cholesteric liquid crystals of different colors (such as red, green and blue) may be all driven by an identical voltage difference. Alternatively, the medium layer 24 may be an inorganic insulation layer. In an alternate embodiment, the organic insulation layer 34 shown in FIG. 3 may be replaced with the black matrix layer 26 to achieve similar effects.

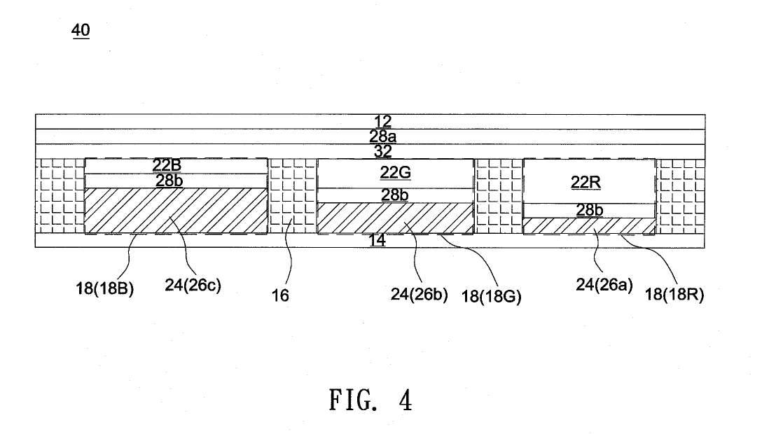

FIG. 4 shows a schematic diagram of a liquid crystal display device according to another embodiment of the invention. Referring to FIG. 4, in a liquid crystal display device 40, the transparent electrode layer 28a is disposed between the first substrate 12 and the fence structure 16, the transparent electrode layer 28b is disposed in the sub-pixel channels 18, and the medium layer 24 is disposed on the second substrate 14. In this embodiment, the medium layer 24 includes the black matrix 26a in the red sub-pixel channel 18R, the black matrix 26b in the green sub-pixel channel 18G, and the black matrix 26c in the blue sub-pixel channel 18B. A thickness of the black matrix 26a is smaller than a thickness of the black matrix 26b, and a thickness of the black matrix 26b is smaller than a thickness of the black matrix 26c. Therefore, electric fields of cholesteric liquid crystals may vary according to the different thicknesses of the black matrix 26, and thus the cholesteric liquid crystals of different colors (such as red, green and blue) may be all driven by an identical voltage difference.

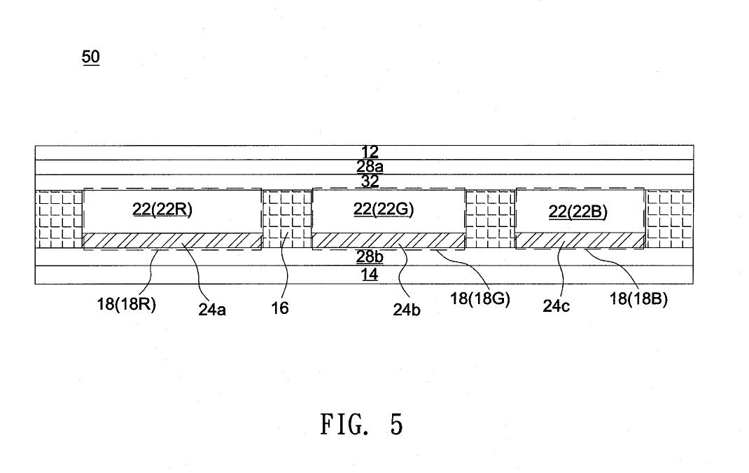

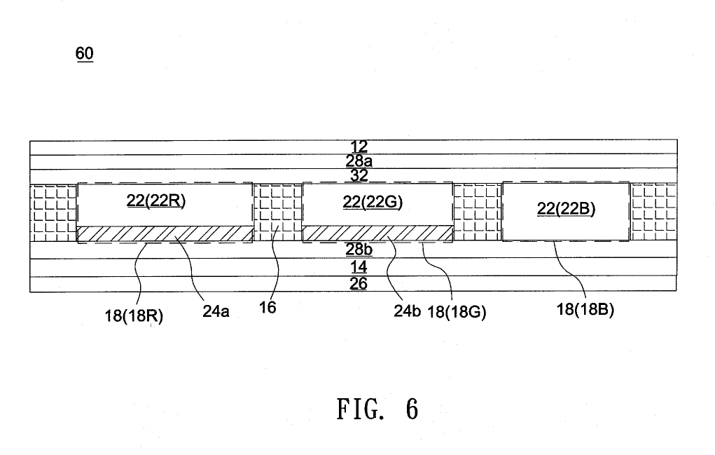

FIG. 5 shows a schematic diagram of a liquid crystal display device according to another embodiment of the invention. Referring to FIG. 5, a liquid crystal display device 50 has a medium layer 24a in the red sub-pixel channel 18R, a medium layer 24b in the green sub-pixel channel 18G, and a medium layer 24c in the blue sub-pixel channel 18B. In this embodiment, the medium layers 24a, 24b and 24c have mutually different dielectric constants. Therefore, electric fields of cholesteric liquid crystals may vary according to the different dielectric constants of the medium layers 24a, 24b and 24 to drive cholesteric liquid crystals of different colors at an identical voltage difference, even the medium layers 24a, 24b and 24 have the same thickness. Note, in this embodiment, the medium layers 24a, 24b and 24c are not limited to a specific material. For example, each of the medium layers 24a, 24b and 24c may be an organic insulation layer, an inorganic insulation layer, or a black matrix. Further, in an alternate embodiment shown in FIG. 6, a liquid crystal display device 60 has a medium layer 24a in the red sub-pixel channel 18R and a medium layer 24b in the green sub-pixel channel 18G, but the blue sub-pixel channel 18B is not provided with a medium layer 24c. The medium layer 24a and the medium layer 24b may have an identical thickness but different dielectric constants. Therefore, electric fields of cholesteric liquid crystals may vary according to the different dielectric constants of the medium layers 24a and 24b or the existence of the medium layer 24c in a sub-pixel channel 18, and thus the cholesteric liquid crystals of different colors (such as red, green and blue) may be all driven by an identical voltage difference. In one embodiment, each of the medium layer 24a and the medium layer 24b may be a black matrix or an insulation layer. As shown in FIG. 6, since the blue sub-pixel channel 18B is not provided with a black matrix or an insulation layer, a black matrix layer 26 may be disposed on one side of the second substrate 14 facing away from the sub-pixel channels 18.

According to the above embodiments, electric fields of cholesteric liquid crystals of different colors respectively in different sub-pixel channels may vary according to the different thicknesses, different material characteristics, or the existence of a medium layer in the different sub-pixel channels. Therefore, the cholesteric liquid crystals of different colors may be all driven by an identical voltage difference to thus simplify the entire driving architecture.

In one embodiment, each of the red cholesteric liquid crystal 22R, the green cholesteric liquid crystal 22G, and the blue cholesteric liquid crystal 22B may include a corresponding colored pigment, a nematic liquid crystal with a chiral dopant, or a polymer dispersed liquid crystal. Further, the fence structure 16 may be formed form an organic or an inorganic material.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A liquid crystal display device, comprising:
a first substrate and a second substrate opposite the first substrate;
a fence structure disposed between the first substrate and the second substrate to divide a space between the first substrate and the second substrate into different sub-pixel channels;
a plurality of cholesteric liquid crystals having mutually different colors and disposed into the sub-pixel channels to form different liquid crystal cells having mutually different colors; and
a medium layer disposed in at least one of the sub-pixel channels to allow the liquid crystal cells to have mutually different cell gaps.

2. The liquid crystal display device as claimed in claim 1, wherein the medium layer is a black matrix or an insulation layer.

3. The liquid crystal display device as claimed in claim 1, wherein a number of the sub-pixel channels and a number of the liquid crystal cells having mutually different colors are both equal to three, the medium layer is disposed in at least two of the sub-pixel channels, and the medium layer is disposed in the different sub-pixel channels at different thicknesses.

4. The liquid crystal display device as claimed in claim 1, further comprising:
a first transparent electrode layer disposed between the first substrate and the fence structure; and
a second transparent electrode layer disposed between the second substrate and the fence structure, wherein the medium layer is disposed on the second transparent electrode layer.

5. The liquid crystal display device as claimed in claim 4, wherein the sub-pixel channels comprises a red sub-pixel channel, a green sub-pixel channel and a blue sub-pixel channel, the medium layer comprises a first black matrix disposed in the red sub-pixel channel, a second black matrix disposed in the green sub-pixel channel, and a thickness of the first black matrix is greater than a thickness of the second black matrix.

6. The liquid crystal display device as claimed in claim 5, wherein the medium layer further comprises a third black matrix disposed in the blue sub-pixel channel, and the thickness of the second black matrix is greater than a thickness of the third black matrix.

7. The liquid crystal display device as claimed in claim 4, wherein the sub-pixel channels comprises a red sub-pixel channel, a green sub-pixel channel and a blue sub-pixel channel, the medium layer is an insulation layer, a thickness of a part of the insulation layer in the red sub-pixel channel is greater than a thickness of a part of the insulation layer in the green sub-pixel channel, and the thickness of the part of the insulation layer in the green sub-pixel channel is greater than a thickness of a part of the insulation layer in the blue sub-pixel channel.

8. The liquid crystal display device as claimed in claim 4, wherein the sub-pixel channels comprises a red sub-pixel channel, a green sub-pixel channel and a blue sub-pixel channel, the medium layer is an insulation layer and disposed in the red sub-pixel channel and the green sub-pixel channel but not in the blue sub-pixel channel, and a thickness of a part of the insulation layer in the red sub-pixel channel is greater than a thickness of a part of the insulation layer in the green sub-pixel channel.

9. The liquid crystal display device as claimed in claim 1, further comprising:
a first transparent electrode layer disposed between the first substrate and the fence structure; and
a second transparent electrode layer disposed in the sub-pixel channels, wherein the medium layer is disposed on the second substrate.

10. The liquid crystal display device as claimed in claim 9, wherein the sub-pixel channels comprises a red sub-pixel channel, a green sub-pixel channel and a blue sub-pixel channel, the medium layer comprises a first black matrix disposed in the red sub-pixel channel, a second black matrix disposed in the green sub-pixel channel, and a thickness of the first black matrix is smaller than a thickness of the second black matrix.

11. The liquid crystal display device as claimed in claim 10, wherein the medium layer further comprises a third black matrix disposed in the blue sub-pixel channel, and a thickness of the second black matrix is smaller than a thickness of the third black matrix.

12. The liquid crystal display device as claimed in claim 1, further comprising:
an adhesive layer disposed between the fence structure and the first substrate.

13. The liquid crystal display device as claimed in claim 1, wherein each of the cholesteric liquid crystals comprises a colored pigment, a nematic liquid crystal with a chiral dopant, or a polymer dispersed liquid crystal.

14. The liquid crystal display device as claimed in claim 1, wherein the fence structure comprises an organic material.

15. The liquid crystal display device as claimed in claim 1, wherein the fence structure comprises an inorganic material.

16. The liquid crystal display device as claimed in claim 1, wherein the fence structure has a plurality of partition walls to partition the space to form the sub-pixel channels.

17. A liquid crystal display device, comprising:
a first substrate and a second substrate opposite the first substrate;
a fence structure disposed between the first substrate and the second substrate to divide a space between the first substrate and the second substrate into different sub-pixel channels;
a plurality of cholesteric liquid crystals having mutually different colors and disposed into the sub-pixel channels to form different liquid crystal cells having mutually different colors; and
a plurality of medium layers respectively disposed in the sub-pixel channels, wherein the medium layers have mutually different dielectric constants.

18. The liquid crystal display device as claimed in claim 17, wherein each of the medium layers is an insulation layer or a black matrix.

19. A liquid crystal display device, comprising:
a first substrate and a second substrate opposite the first substrate;
a fence structure disposed between the first substrate and the second substrate to divide a space between the first substrate and the second substrate into at least a red sub-pixel channel, a green sub-pixel channel, and a blue sub-pixel channel;
a plurality of cholesteric liquid crystals having mutually different colors respectively disposed inside the red sub-pixel channel, the green sub-pixel channel, and the blue sub-pixel channel to form a red liquid crystal cell, a green liquid crystal cell and a blue liquid crystal cell; and
a plurality of medium layers having mutually different dielectric constants and disposed in the red sub-pixel channel and the green sub-pixel channel but not in the blue sub-pixel channel.

20. The liquid crystal display device as claimed in claim 19, wherein each of the medium layers is an insulation layer or a black matrix.
